(19) United States
(12) Patent Application Publication
(10) Pub. No.: US 2015/0318732 A1
(43) Pub. Date: Nov. 5, 2015

(54) RECHARGEABLE HAND TOOL INDUCTION BATTERY DEVICE

(71) Applicant: ROBERT BOSCH GMBH, Stuttgart (DE)

(72) Inventors: Christian Heine, Tuebingen (DE); Guenter Lohr, Leinfelden-Echterdingen (DE); Dragan Krupezevic, Stuttgart (DE); Volker Amann, Augsburg (DE); Juergen Mack, Goeppingen (DE); Jan Breitenbach, Stuttgart (DE); Marcin Rejman, Waiblingen (DE)

(21) Appl. No.: 14/653,409

(22) PCT Filed: Dec. 18, 2013
(86) PCT No.: PCT/EP2013/077145

§ 371 Date: Jun. 18, 2015

(30) Foreign Application Priority Data
Dec. 21, 2012 (DE) 102012112884.7
Dec. 21, 2012 (DE) 102012112996.7
Dec. 17, 2013 (DE) 102013226220.5

(51) Int. Cl. H02J 7/02; H02J 7/00; H01M 10/46

(52) U.S. Cl. CPC H02J 7/025; H01M 10/46; H02J 7/0042; H02J 7/0052; H02J 2007/0062

(57) ABSTRACT

An inductive rechargeable handheld tool battery apparatus includes: a cell unit; and a secondary charging unit provided for direct energy acceptance upon charging of the cell unit, which secondary charging unit has at least one first integrated charging interface constituted by an induction coil, and at least one second integrated charging interface.

### BACKGROUND OF THE INVENTION

1. Field of the Invention

The present invention relates to an inductive rechargeable hand tool battery device.

2. Description of the Related Art

An inductive rechargeable handheld tool battery apparatus having a cell unit and having a secondary charging unit that is provided for direct energy acceptance upon charging of the cell unit, and that has at least one first integrated charging interface that is constituted by an induction coil, has already been proposed.

### BRIEF SUMMARY OF THE INVENTION

The invention provide an inductive rechargeable handheld tool battery apparatus having a cell unit and having a secondary charging unit that is provided for direct energy acceptance upon charging of the cell unit, and that has at least one first integrated charging interface that is constituted by an induction coil.

It is proposed that the secondary charging unit have at least one second integrated charging interface. An “inductive rechargeable handheld tool battery apparatus” is to be understood in this connection in particular as an inductive rechargeable battery apparatus for a handheld power tool. An “inductive rechargeable battery apparatus” is to be understood here in particular as a rechargeable battery apparatus that is provided in order to be charged at least in part inductively. A “rechargeable battery apparatus” is to be understood here in particular as an apparatus for temporarily storing electrical energy, in particular a rechargeable battery. This is to be understood in particular as a rechargeable reservoir. A variety of rechargeable battery apparatuses that seem useful to one skilled in the art are conceivable, but what is to be understood thereby in particular is a rechargeable lithium ion battery. A “handheld power tool” is furthermore to be understood here in particular as a workpiece-processing machine, but advantageously as a power drill, a drill driver and/or impact driver, a saw, a plane, a screwdriver, a milling cutter, a grinder, an angle grinder, a garden tool, and/or a multifunction tool. A “cell unit” is furthermore to be understood in this connection in particular as a part of a rechargeable battery apparatus that is directly provided in order to temporarily store electrical energy. Preferably this is to be understood in particular as a unit that is provided in order to store electrical energy temporarily on an electrochemical basis. Preferably this is to be understood in particular as a rechargeable unit. Particularly preferably, the cell unit is made up of one or more cell elements that are in particular electrically connected to one another. A variety of cell elements that seem useful to one skilled in the art are conceivable, but they are to be understood in particular as lithium ion cells. A “secondary charging unit” is furthermore to be understood in this connection in particular as a unit that is provided for direct energy acceptance upon charging of the cell unit. This is preferably to be understood as a unit that is provided in order to accept energy from a handheld power tool charging apparatus and to convey it to the cell unit for charging. This is preferably to be understood in particular as a unit that is additionally provided in order to adapt an accepted energy of the cell unit. Particularly preferably this is to be understood in particular as a unit that is additionally provided in order to control and/or regulate a charging operation. In addition, “provided” is to understood in this connection in particular to mean specially programmed, designed, and/or equipped. A “charging interface” is to be understood in this connection in particular as an element or an apparatus that is provided, in a charging mode, in order to directly create a connection, in particular a directly and/or indirectly electrical connection, to a handheld tool charging apparatus. The connection can be made both wirelessly and in wire-based fashion. Preferably this is to be understood as an element or an element or an apparatus that is provided directly in order to accept, in a charging mode, an energy delivered from a charging interface of a handheld tool charging apparatus. An “integrated charging interface” is furthermore to be understood in this connection in particular as a charging interface that is fixedly installed in the inductive rechargeable handheld tool battery apparatus. This is preferably to be understood in particular as a charging interface that is already fixedly installed in a factory state and thus differs in particular from a subsequently installed element and/or from a subsequently installed apparatus.

An “induction coil” is furthermore to be understood in this context in particular as an element that is made up at least in part of an electrical conductor, in particular a wound electrical conductor, that is disposed at least in part in the shape of a circular disk. Preferably a voltage is induced in the electrical conductor in particular upon application of a magnetic field, and/or the conductor generates a magnetic field upon application of a voltage. This is preferably to be understood in particular as a coil that is provided in order to deliver and/or, in particular, accept energy for a charging mode in the form of a magnetic field. Particularly preferably this is to be understood as a charging coil of a charging unit, in this connection in particular a secondary charging unit.

Thanks to the configuration according to the present invention of the inductive rechargeable handheld tool battery apparatus, the cell unit can advantageously be charged in various ways, in particular via various charging interfaces. A particularly advantageously high degree of flexibility for a charging mode can thereby, in particular, be achieved.

It is further proposed that at least the first integrated charging interface be connected to the cell unit nondetachably without tools and/or destruction. Preferably the first integrated charging interface and the second integrated charging interface are connected to the cell unit nondetachably without tools and/or destruction. “Nondetachably without tools and/or destruction” is to be understood in this connection in particular to mean that at least the first integrated charging interface is connected to the cell unit fixedly and nondetachably without a tool and/or without destruction of at least a part of the inductive rechargeable handheld tool battery apparatus. This is preferably to be understood in particular to mean that the first integrated charging interface is connected to the cell unit nondetachably for an operator in an intended use. The result is that, in particular, a particularly reliable charging interface can be furnished. Disassembly by an operator, and a possible loss associated therewith, can furthermore thereby be avoided.

It is furthermore proposed that the second integrated charging interface be constituted by a wire-based contact charging interface. A “wire-based contact charging interface” is to be understood in this connection in particular as a charging interface that is provided, in a charging mode, in order to create a connection via a direct, in particular electrically conductive contact point. Preferably this is to be understood as a charging interface that has at least one contact point and that is provided, in order to create a connection, in order to bring the contact point into contact with a contact point of the handheld tool charging apparatus and/or with another apparatus. Preferably the contact point is constituted by at least one electrically conductive contact surface and/or at least one electrically conductive contact element. Particularly preferably, the charging interface is moreover provided in order to enter into a retaining connection in order to position the contact point. Advantageously, the retaining connection is embodied as a latching connection, as a positive-fit slide-in connection, and/or as another connection that seems useful to one skilled in the art. A particularly advantageous charging interface can thereby be furnished.

It is further proposed that the first integrated charging interface and/or the second integrated charging interface be provided, in addition to direct energy acceptance upon charging of the cell unit, to transfer energy of the cell unit to a handheld power tool. Preferably the first integrated charging interface and/or the second integrated charging interface are provided for a bidirectional energy exchange. A “bidirectional energy exchange” is to be understood in this connection in particular to mean that the first integrated charging interface and/or the second integrated charging interface is/are provided in order to accept energy of an interface of a device differing from the inductive rechargeable handheld tool battery apparatus and to deliver energy to such an interface. As a result, at least one of the at least two charging interfaces can be used for multiple functions. The result is, in particular, a saving in terms of components.

It is further proposed that the second integrated charging interface, in addition to energy acceptance upon charging of the cell unit, be provided in order to transfer energy of the cell unit to a handheld power tool. Preferably the second integrated charging interface is provided for a bidirectional energy exchange. As a result, the second integrated charging interface can be used for multiple functions. The result is, in particular, a saving in terms of components.

It is further proposed that the secondary inductive charging unit have a calculation unit that is provided in order to control and/or regulate a charging operation of the cell unit via the first integrated charging interface and via the second integrated charging interface. A “calculation unit” is to be understood in this connection in particular as a unit having an information input, an information processing system, and an information output. Advantageously, the calculation unit has at least a processor, a memory, input and output means, further electrical components, an operating program, regulation routines, control routines, and/or calculation routines. Preferably the components of the calculation unit are disposed on a common circuit board and/or advantageously in a common housing. A “charging operation” is moreover intended to be understood in this connection in particular as an operation in which the cell unit of the rechargeable battery apparatus is supplied externally with energy. Preferably this is to be understood in particular as an operation in which the cell unit of the rechargeable battery apparatus temporarily stores externally delivered energy. What can be achieved thereby in particular is that a suitable, or a utilized, charging interface is used automatically by the calculation unit for a charging operation. A charging operation via the first integrated charging interface and via the second integrated charging interface can furthermore thereby be advantageously managed and controlled and/or regulated. The result in particular is that only one calculation unit is required, so that a number of units can be minimized.

It is furthermore proposed that the inductive rechargeable handheld tool battery apparatus have a housing unit. A “housing unit” is to be understood in this connection in particular as a unit that surrounds at least a large part of the inductive rechargeable handheld tool battery apparatus with the exception of the housing unit itself. Preferably the unit is provided for protection of the inductive rechargeable handheld tool battery apparatus. Particularly preferably, the unit constitutes at least in part a wall, in particular a plastic wall. “At least a large part” is to be understood in particular to mean at least more than 50%, preferably at least more than 70%, and particularly preferably at least more than 90%. A particularly advantageous inductive rechargeable handheld tool battery apparatus can thereby be furnished. In addition, a particularly robust inductive rechargeable handheld tool battery apparatus can in particular thereby be furnished.

It is moreover proposed that the first integrated charging interface and the second integrated charging interface be disposed in integrated fashion in the housing unit. “Integrated” is to be understood in this connection in particular to mean that the first integrated charging interface and the second integrated charging interface are installed fixedly in the housing unit of the inductive rechargeable handheld tool battery apparatus. Preferably this is to be understood in particular to mean that the first integrated charging interface and the second integrated charging interface are disposed with at least a large part of their volume inside the housing unit. “At least a large part of the volume” is to be understood here in particular to mean at least more than 50%, preferably at least more than 70%, and particularly preferably at least more than 90% of the volume. The result is that, in particular, particularly reliable charging interfaces can be furnished. A disassembly of the charging interfaces by an operator, and a possible loss associated therewith, can furthermore thereby be avoided.

It is furthermore proposed that the first integrated charging interface be disposed on a side of the housing unit which is located at least approximately opposite the second integrated charging interface. In principle, however, it would also be conceivable for the charging interfaces simply to be disposed on different sides of the housing unit. “Located at least approximately opposite” is to be understood in this context in particular to mean that the first integrated charging interface is disposed with an offset of at least approximately 180° with respect to the second integrated charging interface in terms of a center point of the housing unit, in particular measured based on a smallest angle. “At least approximately” is to be understood here in particular to mean that a deviation from 180° is equal to less than 15°, preferably less than 10°, and particularly preferably less than 5°. The result is that, in particular, an advantageous differentiation of the charging interfaces can be ensured. Mutual interference between the charging interfaces can furthermore thereby be avoided.

A system having a handheld tool charging apparatus and having an inductive rechargeable handheld tool battery apparatus is furthermore proposed. Preferably the handheld tool charging apparatus has at least one contact charging interface and/or at least one inductive charging interface. A “handheld tool charging apparatus” is to be understood in this context in particular as an apparatus for charging rechargeable handheld tool battery apparatuses, in particular rechargeable batteries and particularly preferably an inductive rechargeable handheld tool battery apparatus. Preferably the apparatus has at least one control unit and/or regulation unit that is provided in order to control and/or regulate a charging operation. The result is in particular that an advantageous system can be furnished. In particular, the inductive rechargeable handheld tool battery apparatus can thereby be advantageously charged.

It is furthermore proposed that the handheld tool charging apparatus be constituted by a contact-based handheld tool charging apparatus. It is thereby possible, in particular, to furnish an advantageous system. In particular, the inductive rechargeable handheld tool battery apparatus can thereby advantageously be charged in contact-based fashion. The result is in turn that, in particular, a particularly energy-saving and low-stress charging operation can be achieved, so that in particular the stress on the inductive rechargeable handheld tool battery apparatus is reduced and electricity costs can be lowered.

It is further proposed that the handheld tool charging apparatus be constituted by an inductive handheld tool charging apparatus. The result is that, in particular, an advantageous system can be furnished. In particular, the inductive rechargeable handheld tool battery apparatus can thus advantageously be charged inductively. The result in turn is that the inductive rechargeable handheld tool battery apparatus can be protected from dirt, dust, and/or moisture in particular during a charging operation. Furthermore, by way of the handheld tool charging apparatus, inductive rechargeable handheld tool battery apparatuses having different wire-based charging interfaces and identical inductive charging interfaces can thus be charged on the same handheld tool charging apparatus. The result in particular is that a plurality of different inductive rechargeable handheld tool battery apparatuses can be charged with the handheld tool charging apparatus.

It is furthermore proposed that the system have at least one further handheld tool charging apparatus that is constituted by an inductive handheld tool charging apparatus. Preferably the contact-based handheld tool charging apparatus is embodied, in particular, separately from the further inductive handheld tool charging apparatus. What can be achieved thereby in particular is that the inductive rechargeable handheld tool battery apparatus can be charged by an operator in different ways, in particular in inductive or contact-based fashion. A charging operation can preferably thereby be adapted to the present requirements of an operator. For a low-stress, energy-saving charging operation, the contact-based handheld tool charging apparatus can in particular be used. For a protected charging operation, in particular in dirty and/or dusty environments, the inductive handheld tool charging apparatus can be used. It would be conceivable in particular in this context for the inductive rechargeable handheld tool battery apparatus to be charged in particular via the contact-based handheld tool charging apparatus, for example, at home and/or in an office, i.e. in clean, uncontaminated environments. The result in particular is that a particularly energy-saving and low-stress charging operation can be achieved, so that in particular a stress on the inductive rechargeable handheld tool battery apparatus is low, and electricity costs can be lowered. Conversely, for example, on construction sites and/or while traveling in a transporter, i.e. in dirty, dusty, and/or moist environments, the inductive rechargeable handheld tool battery apparatus is charged via the inductive handheld tool charging apparatus. The result is that the inductive rechargeable handheld tool battery apparatus is protected from dirt, dust and/or moisture, in particular, during charging operation. Preferably the inductive rechargeable handheld tool battery apparatus can in particular be charged in a state installed on a handheld power tool, since the contacts of a wire-based contact charging interface of the inductive rechargeable handheld tool battery apparatus can thereby be protected. The result is that in particular an advantageously high degree of working reliability can be achieved. In principle it would also be conceivable for the inductive rechargeable handheld tool battery apparatus to be charged via the contact-based handheld tool charging apparatus while traveling, in order to avoid slippage of the inductive rechargeable handheld tool battery apparatus. Furthermore, by way of the inductive handheld tool charging apparatus, inductive rechargeable handheld tool battery apparatuses having different wire-based charging interfaces and identical inductive charging interfaces can thus be charged on the same handheld tool charging apparatus. The result in particular is that a plurality of different inductive rechargeable handheld tool battery apparatuses can be charged with the handheld tool charging apparatus.

Alternatively, it is proposed that the handheld tool charging apparatus be constituted by a combination charging apparatus. Preferably the at least one handheld tool charging apparatus has at least one contact charging interface and at least one inductive charging interface. Particularly preferably, the handheld tool charging apparatus has both an inductive charging side and a contact charging side. The result that can be achieved thereby is in particular that the inductive rechargeable handheld tool battery apparatus can in particular be charged in different ways, e.g. in particular in inductive or contact-based fashion. In particular, a charging operation can thereby be adapted to the present requirements of an operator. For a low-stress, energy-saving charging operation, a contact charging side can in particular be used. For a protected charging operation, in particular in dirty, dusty, and/or moist environments, an inductive charging side can be used.

It is further proposed that the handheld tool charging apparatus, in particular the inductive handheld tool charging apparatus, be provided in order to charge inductive rechargeable handheld tool battery apparatuses having at least two different rated voltages. Preferably the handheld tool charging apparatus is provided in order to charge inductive rechargeable handheld tool battery apparatuses having at least two substantially different rated voltages. Preferably the handheld tool charging apparatus is provided in order to charge inductive rechargeable handheld tool battery apparatuses having at least three and particularly preferably having at least four different rated voltages. A “rated voltage” is to be understood in this connection in particular as a specific value of an electrical voltage of inductive rechargeable handheld tool battery apparatuses in normal operation. “Substantially different” is to be understood in this connection in particular to mean that the rated voltages differ from one another by at least 5%, preferably at least 10%, and particularly preferably at least 15% of the higher rated voltage. The result is that, advantageously, different inductive rechargeable handheld tool battery apparatuses, in particular inductive rechargeable handheld tool battery apparatuses having different rated voltages, can be charged. Furthermore, the handheld tool charging apparatus can thereby also be used for further inductive rechargeable handheld tool battery apparatuses differing from the inductive rechargeable handheld tool battery apparatus according to the present invention. One handheld tool charging apparatus can thus be used for different inductive rechargeable handheld tool battery apparatuses, so that a required number of handheld tool charging apparatuses can be minimized.

It is moreover proposed that the system have a rechargeable handheld tool battery apparatus that has only one charging interface constituted by a wire-based contact charging interface. The result is that, in particular, an advantageous system can be furnished. In addition, in particular, an individually usable system can thereby be furnished.

It is furthermore proposed that the system have an adapter apparatus for universal energy transfer, having at least one integrated charging interface that is constituted by an induction coil. Preferably the adapter apparatus is constituted by a wireless adapter apparatus. An “adapter apparatus” is to be understood in particular as an apparatus that, at least during one operating mode, receives an energy with which, in at least one operating state, at least one rechargeable battery unit is charged and/or one device is supplied with energy. Advantageously, the adapter apparatus receives at least one energy having a power level of at least 10 watts, advantageously at least 100 watts, particularly advantageously at least 500 watts. A “wireless adapter apparatus” is to be understood in particular as an adapter apparatus that receives an energy that has been transferred to the adapter apparatus through at least one electrically nonconductive medium, i.e. through a material having a specific resistance of more than 0.1 Ω·mm²/m, advantageously more than 1 Ω·mm²/m, particularly advantageously more than 10 Ω·mm²/m. Advantageously, the wireless adapter apparatus receives an inductively transferred energy. Alternatively and/or additionally, the wireless adapter apparatus could receive a capacitive energy, an electromagnetic energy, and/or a mechanical energy. The result is that an apparatus with which various devices and rechargeable handheld tool battery apparatuses, in particular conventional rechargeable handheld tool battery apparatuses, can be charged and/or operated with an advantageously wirelessly transferred energy, can be furnished in physically simple and inexpensive fashion. The result is that, in particular, high levels of reliability and convenience can be achieved. Furthermore, a required number of handheld tool charging apparatuses can thereby be minimized.

It is further proposed that the adapter apparatus have at least one attachment region for acceptance of a wire-based contact charging interface of the rechargeable handheld tool battery apparatus. Preferably the acceptance region has electrical contacts for furnishing energy. Particularly preferably, the acceptance region is provided as a charging interface. The result is that an apparatus with which conventional rechargeable handheld tool battery apparatuses that have only a wire-based contact charging interface can be charged with an advantageously wirelessly transferred energy, can be furnished in physically simple and inexpensive fashion. Furthermore, a required number of handheld tool charging apparatuses can be minimized. Different adapter apparatuses can moreover be furnished for different rechargeable handheld tool battery apparatuses.

It is further proposed that the adapter apparatus have at least one USB socket for acceptance of a USB plug connector. Preferably the USB socket is provided for furnishing energy. Particularly preferably, the USB socket is provided as a charging interface. The result is that the handheld tool charging apparatus can advantageously be used universally. It is thereby preferably possible, in particular, for various devices that can be supplied with energy in particular via a USB cable and/or a USB connector to be charged and/or operated with an advantageously wirelessly transferred energy. In addition, a required number of handheld tool charging apparatuses can thereby be minimized.

It is moreover conceivable in particular for the adapter apparatus to have at least one transformer. Preferably the transformer is provided in particular in order to adapt a voltage transferred from the handheld tool charging apparatus to a required rated voltage. The result is that, advantageously, different rechargeable handheld tool battery apparatuses, in particular rechargeable handheld tool battery apparatuses having different rated voltages, can be charged by way of the handheld tool charging apparatus. Different adapter apparatuses are all that is required.

It is furthermore proposed that the handheld tool charging apparatus have at least one cable for supplying energy, having at least one plug connector that is constituted by a motor vehicle plug connector. Preferably the plug connector is constituted by a vehicle voltage socket. In principle, however, another plug connector that seems useful to one skilled in the art would also be conceivable, for example a USB plug connector. The result is that the handheld tool charging apparatus can be supplied with energy, and used for charging, in a motor vehicle.

It is moreover proposed that the system have a handheld power tool. The result is that, in particular, an advantageous system can be furnished. It is moreover possible thereby, in particular, to furnish an individually usable system.

It is further proposed that the system have at least one attachment unit in which the handheld tool charging apparatus is accepted in lossproof fashion and which is provided in order to accept in lossproof fashion an object to be charged, directly or indirectly, for charging. An “attachment unit” is to be understood in this connection in particular as a unit that is provided in order to attach to the handheld tool charging apparatus, in particular detachably, an object to be charged. This is preferably to be understood in particular as a unit that is provided in order to connect an object that is to be charged in positively and/or nonpositively fitting fashion to the handheld tool charging apparatus. “Nonpositively and/or positively connect” is to be understood in this context in particular to mean a detachable connection, a holding force between two components preferably being transferred by way of a geometrical engagement of the components into one another and/or via a frictional force between the components. Further, “detachable” is to be understood in this connection in particular as “nondestructively separable.” It is thereby possible in particular to ensure that an object to be charged, in particular the inductive rechargeable handheld tool battery apparatus, can be connected in lossproof fashion to the handheld tool charging apparatus, and can be positioned securely on the handheld tool charging apparatus. In particular, slippage on the handheld tool charging apparatus of the object to be charged can thereby be avoided, with the result that a consistently high charging quality can be ensured. Moreover, the object to be charged can in particular also be positioned by the attachment unit. Inductive charging in a motor vehicle can thereby in particular also be enabled.

It is further proposed that the at least one attachment unit be provided in order to accept the inductive rechargeable handheld tool battery apparatus in lossproof fashion for charging. It is possible thereby in particular to ensure that the inductive rechargeable handheld tool battery apparatus can be connected in lossproof fashion to the handheld tool charging apparatus, and can be positioned securely on the handheld tool charging apparatus. In particular, slippage on the handheld tool charging apparatus of the inductive rechargeable handheld tool battery apparatus can thereby be avoided, with the result that a consistently high charging quality can be ensured. The inductive rechargeable handheld tool battery apparatus can moreover, in particular, also be positioned by the attachment unit. Inductive charging in a motor vehicle can thereby in particular also be enabled.

It is additionally proposed that the at least one attachment unit be provided in order to accept in lossproof fashion the inductive rechargeable handheld tool battery apparatus, having the handheld power tool attached thereto, for charging of the inductive rechargeable handheld tool battery apparatus. The result is that, advantageously, the handheld power tool along with the inductive rechargeable handheld tool battery apparatus can be securely positioned on the handheld tool charging apparatus. It is thereby possible in particular to prevent the wire-based contact charging interface of the inductive rechargeable handheld tool battery apparatus from becoming soiled. In addition, the inductive rechargeable handheld tool battery apparatus does not need to be separated from the handheld power tool for charging.

It is further proposed that the at least one attachment unit be provided in order to accept in lossproof fashion a case, in which the inductive rechargeable handheld tool battery apparatus is accepted, for charging of the inductive rechargeable handheld tool battery apparatus. Preferably the handheld power tool is also accepted in the case. In principle, further inductive rechargeable handheld tool battery apparatuses and/or further devices can also be accepted in the case. The result is that, advantageously, the case having the inductive rechargeable handheld tool battery apparatus can be positioned securely on the handheld tool charging apparatus. A high level of convenience can thereby advantageously be achieved, in particular because the case does not need to be additionally unloaded for charging, or the inductive rechargeable handheld tool battery apparatus does not need to be specifically taken out of the case, but instead the case having the inductive rechargeable handheld tool battery apparatus accepted therein can be positioned in the attachment unit and charged via the handheld tool charging apparatus. Preferably multiple identical handheld tool charging apparatuses can also be accepted in the attachment unit, so that multiple inductive rechargeable handheld tool battery apparatuses can be charged in the case. In addition, in the context of a fixed installation of the attachment unit, for example in a motor vehicle, the attachment unit can additionally be used to retain the case in order to prevent it from sliding around.

In principle, however, it would also be conceivable for the case to serve additionally or alternatively as an adapter apparatus for universal energy transfer. It would in particular be conceivable in this context for the case to have in its interior an acceptance region for accepting a wire-based contact charging interface of a handheld tool charging apparatus and at least one integrated charging interface that is constituted by an induction coil. The case could thus, for charging, transfer an energy from the handheld tool charging apparatus to a conventional handheld tool charging apparatus connected in the case.

It is furthermore proposed that the system have at least one handheld tool having at least one integrated charging interface which is constituted by an induction coil and by way of which the handheld tool is chargeable via the handheld tool charging apparatus. A “handheld tool” is to be understood in particular as a tool that seems useful to one skilled in the art, but advantageously a power drill, a drill driver, an impact driver, a saw, a plane, a screwdriver, a milling cutter, a grinder, an angle grinder, a garden tool, a construction site measuring device, and/or a multifunction tool. It is thereby possible, in particular, for handheld tools having integrated rechargeable batteries also to be charged advantageously by way of the handheld tool charging apparatus. Preferably the handheld tool can thereby be charged directly and wirelessly. An individually usable system can in particular thereby be furnished. A number of electrical devices can moreover thereby be minimized, in particular, for example, on a construction site.

It is further proposed that the system have at least one thermally insulated container, having at least one magnetic heating element that is configured to be inductively heatable via the handheld tool charging apparatus. Preferably the magnetic heating element is constituted by a ferromagnetic heating element. Particularly preferably the thermally insulated container is constituted by a thermal cup. As a result, the handheld tool charging apparatus can be used in particular to charge the inductive rechargeable handheld tool battery apparatus and to heat the thermally insulated container. The result in particular is that an individually usable system can be furnished. A number of electrical devices can moreover thereby be minimized, in particular, for example, on a construction site.

It is further proposed that the system have a further inductive rechargeable handheld tool battery apparatus that has only one charging interface constituted by a wire-based contact charging interface. The result is that, in particular, an advantageous system can be furnished. Furthermore, an individually usable system can in particular be furnished thereby.

The inductive rechargeable handheld tool battery apparatus according to the present invention is not intended to be limited here to the utilization and embodiment described above. In particular, the inductive rechargeable handheld tool battery apparatus according to the present invention can have, in order to perform a function described herein, a number of individual elements, components, and units which deviates from a number recited herein.

### BRIEF DESCRIPTION OF THE DRAWINGS

FIG. 1 schematically depicts an inductive rechargeable handheld tool battery apparatus according to the present invention having a secondary charging unit, and a handheld tool charging apparatus, in a charging mode.

FIG. 2 is a schematic sectioned depiction, along section line II, of the inductive rechargeable handheld tool battery apparatus according to the present invention and of a portion of the handheld tool charging apparatus.

FIG. 3 shows the inductive rechargeable handheld tool battery apparatus according to the present invention and a handheld power tool, in a power supply mode.

FIG. 4 schematically depicts a system encompassing at least an inductive rechargeable handheld tool battery apparatus according to the present invention, a contact-based handheld tool charging apparatus, and an inductive handheld tool charging apparatus in a charging mode.

FIG. 5 is a schematic sectioned depiction, along section line V, of the system encompassing at least the inductive rechargeable handheld tool battery apparatus according to the present invention, the contact-based handheld tool charging apparatus, and the inductive handheld tool charging apparatus, in a charging mode.

FIG. 6 schematically depicts a system encompassing multiple inductive rechargeable handheld tool battery apparatuses according to the present invention, a contact-based handheld tool charging apparatus, and an alternative inductive handheld tool charging apparatus, in a charging mode.

FIG. 7 schematically depicts an inductive rechargeable handheld tool battery apparatus according to the present invention, a contact-based handheld tool charging apparatus, an inductive handheld tool charging apparatus, a rechargeable handheld tool battery apparatus, and an adapter apparatus.

FIG. 8 schematically depicts an inductive rechargeable handheld tool battery apparatus according to the present invention, a contact-based handheld tool charging apparatus, an inductive handheld tool charging apparatus, a device, and an adapter apparatus.

FIG. 9 schematically depicts an inductive rechargeable handheld tool battery apparatus according to the present invention, an alternative contact-based handheld tool charging apparatus, and an alternative inductive handheld tool charging apparatus, in a charging mode.

FIG. 10 schematically depicts an inductive rechargeable handheld tool battery apparatus according to the present invention, an inductive handheld tool charging apparatus, and an attachment unit.

FIG. 11 schematically depicts two inductive handheld tool charging apparatuses and an attachment unit.

FIG. 12 schematically depicts two inductive rechargeable handheld tool battery apparatuses according to the present invention in a case, the two inductive handheld tool charging apparatuses, and the attachment unit.

FIG. 13 schematically depicts a handheld tool and an inductive handheld tool charging apparatus.

FIG. 14 schematically depicts a thermally insulated container and an inductive handheld tool charging apparatus.

### DETAILED DESCRIPTION OF THE INVENTION

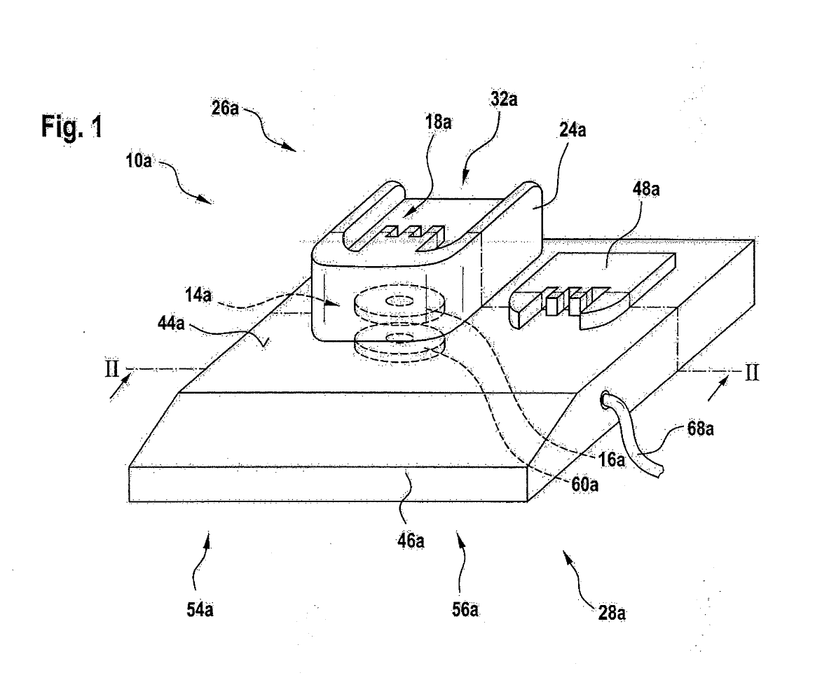

FIG. 1 shows an inductive rechargeable handheld tool battery apparatus 10a according to the present invention having a secondary charging unit 14a, and a handheld tool charging apparatus 28a, in a charging mode. Inductive rechargeable handheld tool battery apparatus 10a has a housing unit 24a. Housing unit 24a has a base side 30a. Inductive rechargeable handheld tool battery apparatus 10a is provided in order to be placed, for example in the context of storage, on base side 30a. On a side of housing unit 24a located opposite base side 30a, housing unit 24a forms an acceptance region 32a. Inductive rechargeable handheld tool battery apparatus 10a is connected via acceptance region 32a, for example, to a handheld power tool 20a or to handheld tool charging apparatus 28a. Acceptance region 32a serves to create an electrical contact between inductive rechargeable handheld tool battery apparatus 10a and handheld power tool 20a and/or between inductive rechargeable handheld tool battery apparatus 10a and handheld tool charging apparatus 28a. Acceptance region 32a serves both to furnish a mechanical and electrical discharge interface and to furnish a mechanical and electrical second integrated charging interface 18a of secondary charging unit 14a. Acceptance region 32a has guidance rails (not shown further), by way of which inductive rechargeable handheld tool battery apparatus 10a can be slid, for attachment purposes, onto an attachment region 34a of handheld power tool 20a. Acceptance region 32a can furthermore, in order to attach inductive rechargeable handheld tool battery apparatus 10a, be slid via the guidance rails onto an attachment region 48a of handheld tool charging apparatus 28a. In principle, however, it would also be conceivable for acceptance region 32a to have, additionally or alternatively to the guidance rails, other guidance elements that seem useful to one skilled in the art, for example guidance ribs and/or guidance grooves and/or individual guidance ridges. Acceptance region 32a represents approximately a congruent negative image of attachment region 34a. Another configuration of acceptance region 32a and/or of the attachment system which seems useful to one skilled in the art would, however, also be conceivable in principle. Also alternative to an acceptance region, equipped with guidance rails, for sliding inductive rechargeable handheld tool battery apparatus 10a into handheld tool 20a transversely to a longitudinal dimension of a handle of handheld power tool 20a, is an acceptance region equipped with guidance ridges for inserting inductive rechargeable handheld tool battery apparatus 10a into a handle of handheld power tool 20a, proceeding from a lower free end of the handle, along a longitudinal dimension of the handle. Inductive rechargeable is handheld tool battery apparatus 10a furthermore has a cell unit 12a and secondary charging unit 14a. Cell unit 12a is provided for the temporary storage of energy. Cell unit 12a is furthermore provided in order to supply handheld power tool 20a with energy. Cell unit 12a is disposed in housing unit 24a. Secondary charging unit 14a is provided for direct energy acceptance upon charging of cell unit 12a. Secondary charging unit 14a is provided in order to accept an energy transferred to inductive rechargeable handheld tool battery apparatus 10a, and thereby to charge cell unit 12a.

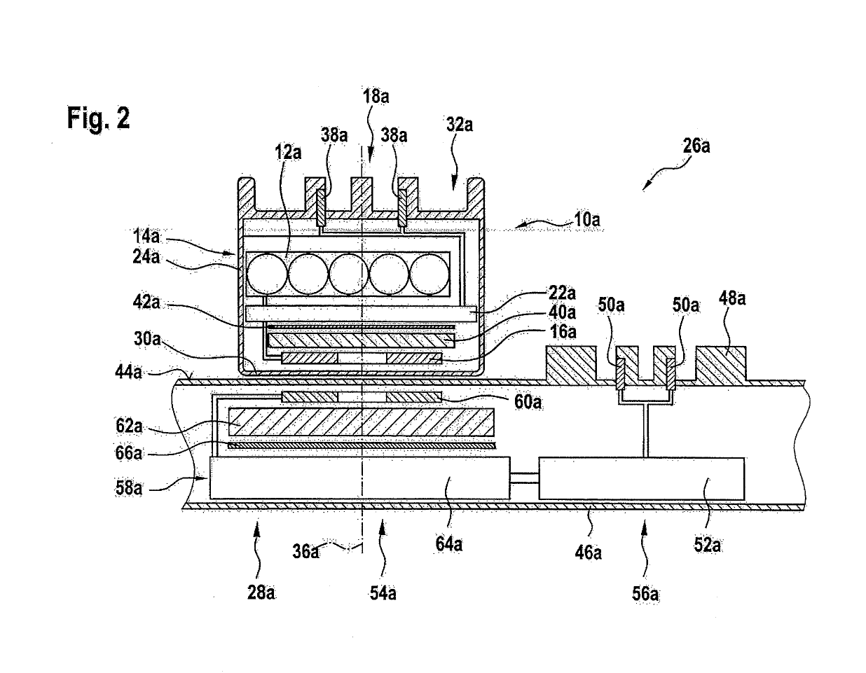

Secondary charging unit 14a has a first integrated charging interface 16a. First integrated charging interface 16a is constituted by an induction coil. First integrated charging interface 16a is provided in order to inductively accept a charging energy of handheld tool charging apparatus 28a. First charging interface 16a is embodied annularly. First charging interface 16a is made up of multiple electrical conductors that extend in a circumferential direction. The electrical conductors are wound in a circumferential direction around a theoretical winding axis 36a. First charging interface 16a has a principal extension plane that is oriented perpendicularly to winding axis 36a. First charging interface 16a furthermore has a principal extension direction in the principal extension plane which is several times greater than an extension of first charging interface 16a perpendicular to the principal extension plane. First integrated charging interface 16a is connected to cell unit 12a nondetachably without tools and destruction. First integrated charging interface 16a is connected to housing unit 24a of inductive rechargeable handheld tool battery apparatus 10a nondetachably without tools and destruction. First charging interface 16a is disposed, on a side facing toward base side 30a, in housing unit 24a (FIG. 2).

Secondary charging unit 14a furthermore has second integrated charging interface 18a. Second integrated charging interface 18a is constituted by a wire-based contact interface. Second charging interface 18a is provided in order to accept a charging energy of handheld tool charging apparatus 28a in wire-based fashion via a direct contact. Second charging interface 18a has two contact elements 38a. Contact elements 38a are constituted by metallic tabs. Contact elements 38a are disposed in part in housing unit 24a. Contact elements 38a project, in acceptance region 32a of housing unit 24a, from an inner side through housing unit 24a onto an outer side. Second integrated charging interface 18a is connected to cell unit 12a nondetachably without tools and destruction. Second integrated charging interface 18a is connected to housing unit 24a of inductive rechargeable handheld tool battery apparatus 10a nondetachably without tools and destruction (FIG. 2). Second integrated charging interface 18a furthermore also serves as a discharge interface for inductive rechargeable handheld tool battery apparatus 10a during operation on handheld power tool 20a (FIG. 2). The wire-based contact interface of second charging interface 18a is consequently also provided in order to deliver a discharge energy, in wire-based fashion via a direct contact, to handheld power tool 20a.

Secondary charging unit 14a furthermore has a calculation unit 22a. Calculation unit 22a is provided in order to control and regulate a charging operation of cell unit 12a via first integrated charging interface 16a and via second integrated charging interface 18a. Calculation unit 22a additionally controls which charging interface 16a, 18a cell unit 12a is charged through. Calculation unit 22a senses the charging interface 16a, 18a through which inductive rechargeable handheld tool battery apparatus 10a is connected to a handheld tool charging apparatus 28a, and thus senses the charging interface 16a, 18a through which cell unit 12a is to be charged. Cell unit 12a can be charged through only one of the two charging interfaces 16a, 18a at the same time. During a charging operation through one charging interface 16a, 18a, the respective other charging interface 16a, 18a is blocked. Calculation unit 22a has a rectifier circuit (not further visible) in order to rectify an alternating voltage entering first charging interface 16a. Calculation unit 22a is furthermore provided in order to sense a fill level of cell unit 12a and to control and regulate the charging operation correspondingly. Secondary charging unit 14a furthermore has a core unit 40a and a shielding unit 42a. Core unit 40a and shielding unit 42a are disposed physically between first charging interface 16 and calculation unit 22a. Core unit 40a is of plate-shaped configuration and is made of a magnetic material. Core unit 40a is provided in order to direct a magnetic flux to be accepted by first charging interface 16a. Shielding unit 42a is provided in order to protect calculation unit 22a and cell unit 12a from interference influences of first charging interface 16a (FIG. 2).

First integrated charging interface 16a and second integrated charging interface 18a are disposed integratedly in housing unit 24a. First integrated charging interface 16a is furthermore disposed on a side of housing unit 24a located oppositely to second integrated charging interface 18a. Proceeding from acceptance region 32a of housing unit 24a of inductive rechargeable handheld tool battery apparatus 10a toward base side 30a of housing unit 24a of inductive rechargeable handheld tool battery apparatus 10a, the sequence in housing unit 24a is firstly second charging interface 18a of secondary charging unit 14a, cell unit 12a, calculation unit 22a of secondary charging unit 14a, shielding unit 42a of secondary charging unit 14a, core unit 40a of secondary charging unit 14a, and first charging interface 16a of secondary charging unit 14a (FIG. 2).

Cell unit 12a of inductive rechargeable handheld tool battery apparatus 10a can be charged via first charging interface 16a and via second charging interface 18a by handheld tool charging apparatus 28a. Calculation unit 22a controls, in this context, which charging interface 16a, 18a cell unit 12a is charged through. Cell unit 12a can be charged via only one of the two charging interfaces 16a, 18a at the same time. In order to charge cell unit 12a via first charging interface 16a, inductive rechargeable handheld tool battery apparatus 10a is placed with base side 30a onto an inductive charging surface 44a of handheld tool charging apparatus 28a. Inductive charging surface 44a forms part of a housing unit 26a of handheld tool charging apparatus 28a. Inductive charging surface 44a has a principal extension plane that, with handheld tool charging apparatus 28a positioned as provided, extends parallel to a substrate. Inductive charging surface 44a faces away from the substrate.

In order to charge cell unit 12a via second charging interface 18a, inductive rechargeable handheld tool battery apparatus 10a is slid with acceptance region 32a onto attachment region 48a of housing unit 46a of handheld tool charging apparatus 28a. Acceptance region 32a represents approximately a congruent negative image of attachment region 48a. In the slid-on state, contact elements 38a of second charging interface 18a are in direct contact with contact elements 50a of handheld tool charging apparatus 28a. Contact elements 50a are constituted by metallic tabs. Contact elements 50a are disposed in part in housing unit 46a of handheld tool charging apparatus 28a. Contact elements 50a project, in attachment region 48a of housing unit 46a, from an inner side through housing unit 46a onto an outer side. Contact elements 50a are connected on an inner side, via a lead, to a contact charging electronic system 52a (FIG. 2).

Handheld tool charging apparatus 28a is constituted by a combination charging apparatus with which inductive rechargeable handheld tool battery apparatus 10a can be charged both in wire-based fashion and inductively. In principle, inductive rechargeable handheld tool battery apparatus 10a can also be charged with an exclusively wire-based charging apparatus or with an exclusively inductive charging apparatus. Handheld tool charging apparatus 28a has two sides: an inductive charging side 54a and a contact charging side 56a. The sides can in principle deviate, in an interior of housing unit 46a, from a physical separation. Contact charging side 56a has contact elements 50a and contact charging electronic system 52a. Contact elements 50a are provided in order to transfer energy, in a charging mode, directly onto contact elements 38a of inductive rechargeable handheld tool battery apparatus 10a. Contact charging electronic system 52a forms part of an electronic unit 58a. Electronic unit 58a is associated both with inductive charging side 54a and with contact charging side 56a. Electronic unit 58 is also connected, in a manner not further visible, to a cable 68a for energy delivery. Inductive charging side 54a is provided for wireless energy transfer from handheld tool charging apparatus 28a to inductive rechargeable handheld tool battery apparatus 10a. Inductive charging side 54a is provided in order to convert electrical energy into a magnetic field that can be converted, by first charging interface 16a of secondary charging unit 14a, back into electrical energy. Inductive charging side 54a has a charging coil 60a. Charging coil 60a is embodied substantially identically to first charging interface 16a, constituted by an induction coil, of inductive rechargeable handheld tool battery apparatus 10a. Charging coil 60a is likewise embodied annularly. Charging coil 60a is made up of multiple electrical conductors that extend in a circumferential direction. The electrical conductors are wound in a circumferential direction around theoretical winding axis 36a. Charging coil 60a has a principal extension plane that is oriented perpendicularly to winding axis 36a. Charging coil 60a furthermore has a principal extension direction in the principal extension plane that is several times greater than an extension of charging coil 60a perpendicular to the principal extension plane. Inductive charging side 54a furthermore has a coil unit 62a, an inductive charging electronic system 64a, and a shielding unit 66a. Core unit 62a is embodied approximately identically with respect to core unit 40a of inductive rechargeable handheld tool battery apparatus 10a. Inductive charging electronic system 64a forms part of electronic unit 58a. Shielding unit 66 is provided in order to protect electronic unit 58a from interference influences of charging coil 60a. Inductive charging side 54a is disposed entirely in housing unit 46a. Proceeding from inductive charging surface 44a beneath which inductive charging side 54a is disposed, parallel to a line normal to inductive charging surface 44a toward a center of handheld tool charging apparatus 28a, the sequence is firstly charging coil 60a of inductive charging side 54a, core unit 62a of inductive charging side 54a, shielding unit 66a of inductive charging side 54a, and inductive charging electronic system 64a of inductive charging side 54a (FIG. 2).

Inductive rechargeable handheld tool battery apparatus 10a and handheld tool charging apparatus 28a constitute a system 26a.

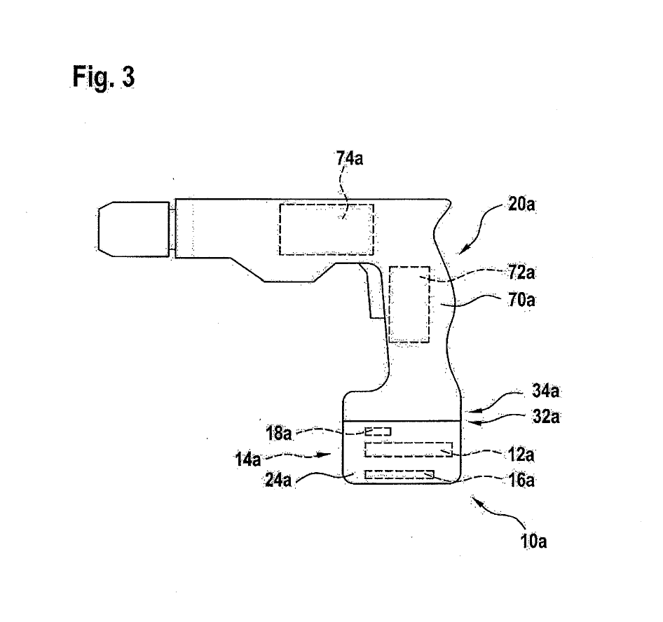

Second charging interface 18a of secondary charging unit 14a of inductive rechargeable handheld tool battery apparatus 10a is provided, in addition to direct energy acceptance upon charging of cell unit 12a, to transfer energy of cell unit 12 to handheld power tool 20a. Inductive rechargeable handheld tool battery apparatus 10a is connected via acceptance region 32a of housing unit 24a and via attachment region 34a of handheld power tool 20a to handheld power tool 20a. Attachment region 34a of handheld power tool 20a forms part of a housing unit 70a of handheld power tool 20a. In the state in which inductive rechargeable handheld tool battery apparatus 10a is slid onto handheld power tool 20a, contact elements 38a of second charging interface 18a are in direct contact with contact elements (not further visible) of handheld power tool 20a. An energy of cell unit 12a is transferred via contact elements 38a of second charging interface 18a to handheld power tool 20a. Inductive rechargeable handheld tool battery apparatus 10a is provided, in a power supply mode, to supply an electronic unit 72a and a motor unit 74a of handheld power tool 20a with energy of cell unit 12a (FIG. 3).

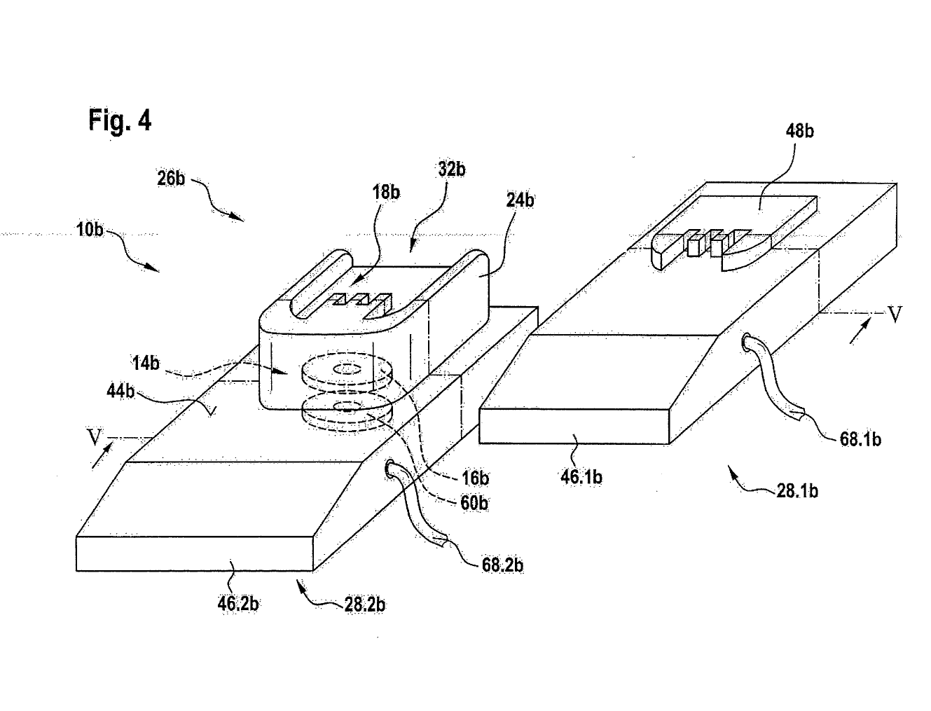

FIGS. 4 to 14 show nine further exemplifying embodiments of the invention. The descriptions below are confined substantially to the differences among the exemplifying embodiments; reference may be made to the description of the other exemplifying embodiments, in particular of FIGS. 1 to 3, with regard to components, features, and functions that remain unchanged. In order to differentiate the exemplifying embodiments, the letter “a” in the reference characters of the exemplifying embodiment in FIGS. 1 to 3 is replaced by the letters “b” to “j” in the reference characters of the exemplifying embodiments of FIGS. 4 to 14. With regard to identically characterized components, in particular with reference to components having identical reference characters, reference may in principle also be made to the drawings and/or the description of the other exemplifying embodiments, in particular of FIGS. 1 to 3.

FIG. 4 shows an inductive rechargeable handheld tool battery apparatus 10b according to the present invention, already described, as well as two alternative handheld tool charging apparatuses 28.1b, 28.2b. One handheld tool charging apparatus 28.1b is constituted by a contact-based handheld tool charging apparatus. The further handheld tool charging apparatus 28.2b is constituted by an inductive handheld tool charging apparatus. Handheld tool charging apparatus 28.1b is constituted by a contact-based handheld tool charging apparatus, and further handheld tool charging apparatus 28.2b is constituted by an inductive handheld tool charging apparatus.

A cell unit 12b of inductive rechargeable handheld tool battery apparatus 10b can be charged via a first charging interface 16b and via a second charging interface 18b. Cell unit 12b of inductive rechargeable handheld tool battery apparatus 10b can be charged by inductive handheld tool charging apparatus 28.2b via first charging interface 16b. Alternatively, cell unit 12b of inductive rechargeable handheld tool battery apparatus 10b can be charged by inductive handheld tool charging apparatus 28.2b via second charging interface 18b.

In order to charge cell unit 12b via first charging interface 16b, inductive rechargeable handheld tool battery apparatus 10b is placed with a base side 30b onto an inductive charging surface 44b of inductive handheld tool charging apparatus 28.2b. Inductive charging surface 44b forms part of a housing unit 46.2b of inductive handheld tool charging apparatus 28.2b. Inductive charging surface 44b has a principal extension plane that, with inductive handheld tool charging apparatus 28.2b positioned as provided, extends parallel to a substrate. Inductive charging surface 44b faces away from the substrate.

Inductive handheld tool charging apparatus 28.2b is provided for wireless energy transfer to inductive rechargeable handheld tool battery apparatus 10b. Inductive handheld tool charging apparatus 28.2b is provided in order to convert electrical energy into a magnetic field that can be converted, by first charging interface 16b of a secondary charging unit 14b, back into electrical energy. Inductive handheld tool charging apparatus 28.2b has for this purpose a charging coil 60b. Inductive handheld tool charging apparatus 28.2b furthermore has a core unit 62b, an inductive charging electronic system 64b, and a shielding unit 66b. Inductive charging electronic system 64b is connected, in a manner not further visible, to a cable 68.2b for energy delivery. Shielding unit 66b is provided in order to protect inductive charging electronic system 64b from interference influences of charging coil 60b. Charging coil 60b, core unit 62b, inductive charging electronic system 64b, and shielding unit 66b are disposed in housing unit 46.2b of inductive handheld tool charging apparatus 28.2b.

In order to charge cell unit 12b via second charging interface 18b, inductive rechargeable handheld tool battery apparatus 10b is slid, with an acceptance region 32b, onto an attachment region 48b of a housing unit 46.1b of contact-based handheld tool charging apparatus 28.1b. Acceptance region 32b represents approximately a congruent negative image of attachment region 48b. In the slid-on state, contact elements 38b of second charging interface 18b are in direct contact with contact elements 50b of contact-based handheld tool charging apparatus 28.1b. Contact elements 50b are constituted by metallic tabs. Contact elements 50b are disposed in part in housing unit 46.1b of contact-based handheld tool charging apparatus 28.1b. Contact elements 50b project, in attachment region 48b of housing unit 46.1b, from an inner side through housing unit 46.1b onto an outer side. Contact elements 50b are connected on an inner side, via a lead, to a contact charging electronic system 52b. Contact elements 50b are provided in order to transfer energy, in a charging mode, directly to contact elements 38b of inductive rechargeable handheld tool battery apparatus 10b. Contact charging electronic system 52b is disposed inside housing unit 46.1b. Contact charging electronic system 52b is connected, in a manner not further visible, to a cable 68.1b for energy delivery.

Contact-based handheld tool charging apparatus 28.1b, inductive handheld tool charging apparatus 28.2b, and inductive rechargeable handheld tool battery apparatus 10b constitute a system 26b.

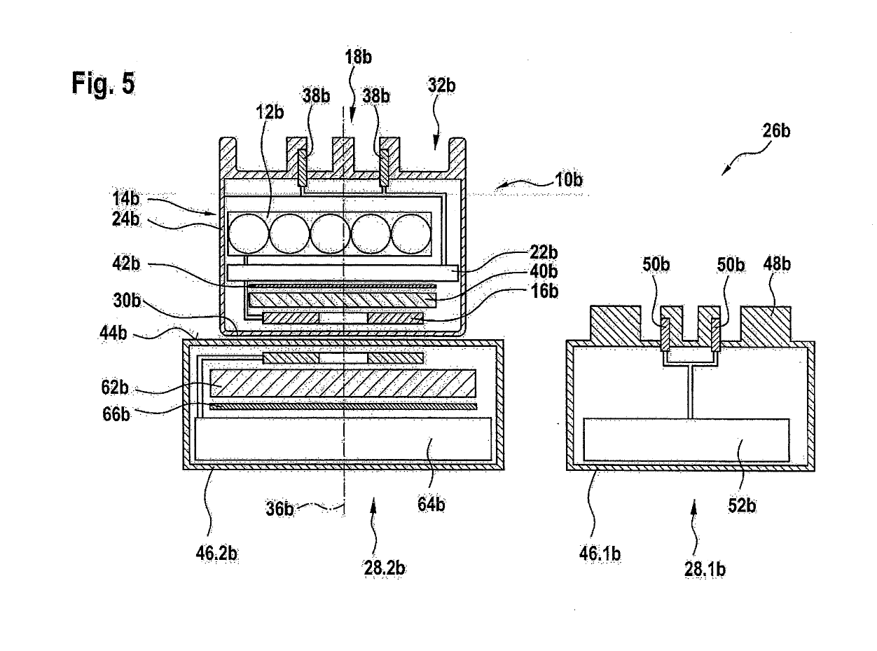

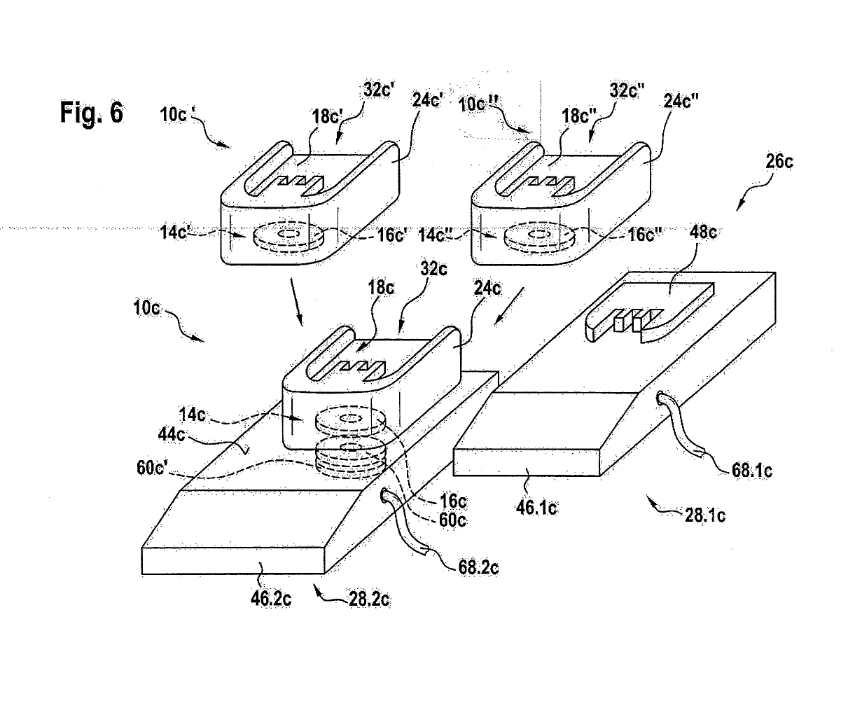

FIG. 6 shows a system 26c having three inductive rechargeable handheld tool battery apparatuses 10c, 10c′, 10c″ according to the present invention, a contact-based handheld tool charging apparatus 28.1c, and an alternative inductive handheld tool charging apparatus 28.2c, in a charging mode. The three inductive rechargeable handheld tool battery apparatuses 10c, 10c′, 10c″ are embodied substantially correspondingly to inductive rechargeable handheld tool battery apparatus 10a of the first exemplifying embodiment of FIGS. 1 to 3. Contact-based handheld tool charging apparatus 28.1c is embodied correspondingly to contact-based handheld tool charging apparatus 28.1b of the second exemplifying embodiment of FIGS. 4 and 5.

The three inductive rechargeable handheld tool battery apparatuses 10c, 10c′, 10c″ each have a cell unit. The three inductive rechargeable handheld tool battery apparatuses 10c, 10c′, 10c″ are of substantially identical configuration with regard to a first charging interface 16c, 16c′, 16c″. The cell units of inductive rechargeable handheld tool battery apparatuses 10c, 10c′, 10c″ each have a rated voltage differing with respect to the other cell units. The cell units of the three inductive rechargeable handheld tool battery apparatuses 10c, 10c′, 10c″ each have a number of cells differing with respect to the other cell units. Inductive rechargeable handheld tool battery apparatus 10c has, by way of example, a rated voltage of 10.8 V. Inductive rechargeable handheld tool battery apparatus 10c′ has, by way of example, a rated voltage of 14.4 V. Inductive rechargeable handheld tool battery apparatus 10c″ has, by way of example, a rated voltage of 18 V. Other rated voltages are, however, also conceivable in principle, for example 3.6 V, 7.2 V, 24 V, or 36 V. Fewer or more than three inductive rechargeable handheld tool battery apparatuses 10c, 10c′, 10c″, having fewer or more than three different rated voltages, can accordingly also be charged with inductive handheld tool charging apparatus 28.2c.

For simplicity of depiction in FIG. 6, the three inductive rechargeable handheld tool battery apparatuses 10c, 10c′, 10c″ are embodied substantially identically in terms of a second charging interface 18c, 18c′, 18c″ for contact-based charging. This serves only for simplicity of depiction. Second charging interface 18c, 18c′, 18c″ can be embodied differently for different rated voltages. Different configurations of charging interfaces 18c, 18c′, 18c″ for contact-based charging are familiar to one skilled in the art.

The cell units of inductive rechargeable handheld tool battery apparatuses 10c, 10c′, 10c″ can be charged each via a first charging interface 16c, 16c′, 16c″ and each via a second charging interface 18c, 18c′, 18c″. The cell units of inductive rechargeable handheld tool battery apparatuses 10c, 10c′, 10c″ can each be charged via first charging interfaces 16c, 16c′, 16c″, all by inductive handheld tool charging apparatus 28.2c. Alternatively, the cell unit of inductive rechargeable handheld tool battery apparatus 10c can be charged by contact-based handheld tool charging apparatus 28.1c via second charging interface 18c. It would in principle also be conceivable, however, for all the inductive rechargeable handheld tool battery apparatuses 10c, 10c′, 10c″ also to be able to be charged by contact-based handheld tool charging apparatus 28.1c. The cell units of inductive rechargeable handheld tool battery apparatuses 10c′, 10c″ can, however, in principle also be charged using an alternative conventional contact-based or inductive handheld tool charging apparatus.

In order to charge the cell units respectively via first charging interface 16c, 16c′, 16c″, the respective inductive rechargeable handheld tool battery apparatus 10c, 10c′, 10c″ is placed with a base side on an inductive charging surface 44c of inductive handheld tool charging apparatus 28.2c. Inductive charging surface 44c forms part of a housing unit 46.2c of inductive handheld tool charging apparatus 28.2c. Inductive charging surface 44c has a principal extension plane that extends, with inductive handheld tool charging apparatus 28.2c positioned as provided, parallel to a substrate. Inductive charging surface 44c faces away from the substrate. Inductive handheld tool charging apparatus 28.2c is provided for wireless energy transfer to inductive rechargeable handheld tool battery apparatus 10c. Inductive handheld tool charging apparatus 28.2c is provided in order to convert electrical energy into a magnetic field that can be converted, by first charging interface 16c of a secondary charging unit 14c, back into electrical energy. Handheld tool charging apparatus 28.2c is provided for this purpose in order to charge inductive rechargeable handheld tool battery apparatuses 10c, 10c′, and 10c″ with three different rated voltages. Handheld tool charging apparatus 28.2c has for this purpose two charging coils 60c, 60c′. Charging coils 60c, 60c′ are respectively provided, individually and in combination, in order to charge inductive rechargeable handheld tool battery apparatuses 10c, 10c′, 10c″ with three different rated voltages. Inductive rechargeable handheld tool battery apparatuses 10c, 10c′, 10c″ are each charged with a corresponding rated voltage as a function of a required rated voltage. Charging coils 60c, 60c′ are each embodied annularly and approximately identically. Charging coils 60c, 60c′ are arranged one behind another when viewed along their winding axis.

Inductive handheld tool charging apparatus 28.2c furthermore has a core unit that is not further visible, an inductive charging electronic system that is not further visible, and a shielding unit that is not further visible. The inductive charging electronic system is connected, in a manner not further visible, to a cable 68.2c for energy delivery. The shielding unit is provided in order to protect the inductive charging electronic system from interference influences of charging coils 60c, 60c′. Charging coils 60c, 60c′, the core unit, the inductive charging electronic system, and the shielding unit are disposed in housing unit 46.2c of inductive handheld tool charging apparatus 28.2c.

Handheld tool charging apparatus 28.2c furthermore has a calculation unit, not further visible, that is provided in order to evaluate at least one parameter of a rated voltage of one of inductive rechargeable handheld tool battery apparatuses 10c, 10c′, 10c″. The calculation unit is provided in order to evaluate a number of cells of a cell unit of inductive rechargeable handheld tool battery apparatuses 10c, 10c′, 10c″ and to infer therefrom a rated voltage. The calculation unit is associated with the two charging coils 60c, 60c′ of handheld tool charging apparatus 28.2c. The calculation unit forms part of the inductive charging electronic system.

The inductive charging electronic system of handheld tool charging apparatus 28.2c furthermore has a control unit and/or regulation unit that is provided in order to control a voltage flowing through charging coils 60c, 60c′ and to adapt it to a rated voltage of one of inductive rechargeable handheld tool battery apparatuses 10c, 10c′, 10c″. Handheld tool charging apparatus 28.2c furthermore has a communication unit, not further visible, that is provided in order to read out at least one parameter of a rated voltage of one of inductive rechargeable handheld tool battery apparatuses 10c, 10c′, 10c″. The communication unit is provided in order to read out a number of cells of the cell unit of inductive rechargeable handheld tool battery apparatuses 10c, 10c′, 10c″. The communication unit is connected to the calculation unit. The communication unit likewise forms part of the inductive charging electronic system. The communication unit is constituted by an NFC interface. Inductive rechargeable handheld tool battery apparatuses 10c, 10c40 , 10c″ likewise each have a communication unit for this purpose. The communication units of inductive rechargeable handheld tool battery apparatuses 10c, 10c′, 10c″ are likewise each constituted by an NFC interface. The communication units each form part of an electronic unit of the respective inductive rechargeable handheld tool battery apparatus 10c, 10c′, 10c″.

Handheld tool charging apparatus 28.2c is provided in order to apply control to one of the two, or to both, charging coils 60c, 60c′ as a function of an inductive rechargeable handheld tool battery apparatus 10c, 10c′, 10c″ that is to be charged. Handheld tool charging apparatus 28.2c is provided in order to apply control to one of the two, or to both, charging coils 60c, 60c′ as a function of a rated voltage of an inductive rechargeable handheld tool battery apparatus 10c, 10c′, 10c″ that is to be charged. When one of inductive rechargeable handheld tool battery apparatuses 10c, 10c′, 10c″ is placed on inductive charging surface 44c, the communication unit of handheld tool charging apparatus 28.2c reads out, via a communication unit of the respectively placed inductive rechargeable handheld tool battery apparatus 10c, 10c′, 10c″, a number of cells of inductive rechargeable handheld tool battery apparatus 10c, 10c′, 10c″. The calculation unit evaluates the number of cells and calculates therefrom a rated voltage. Based on the calculated rated voltage, control is applied to one of the two, or to both, charging coils 60c, 60c′ in such a way that they generate, individually or together, a corresponding rated voltage.

Contact-based handheld tool charging apparatus 28.1c, inductive handheld tool charging apparatus 28.2c, and inductive rechargeable handheld tool battery apparatus 10c constitute system 26c.

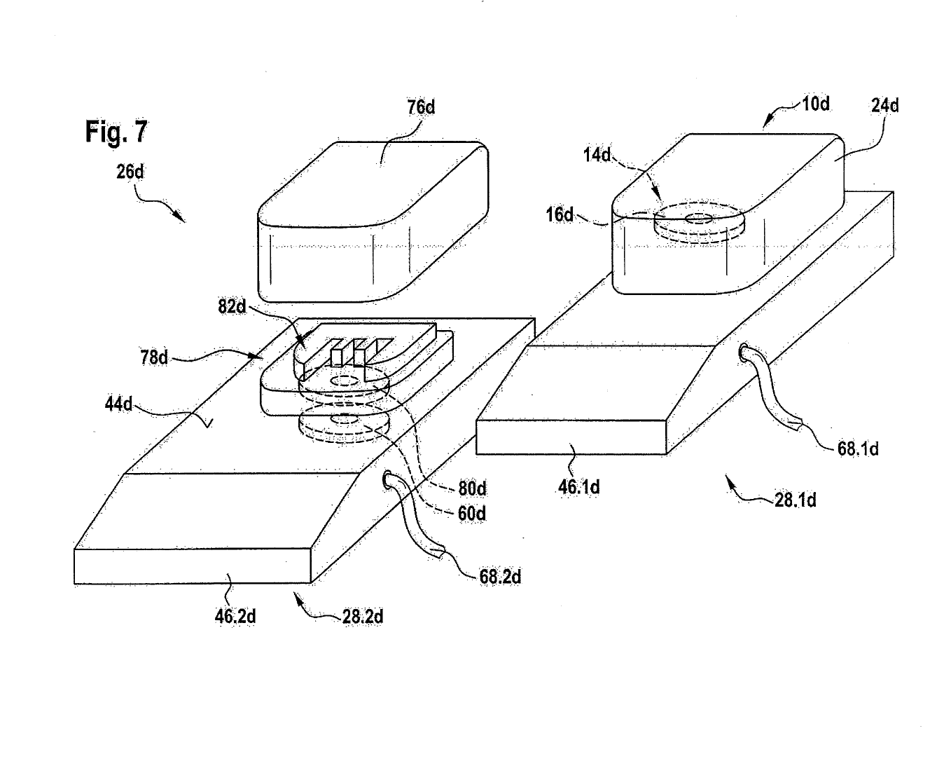

FIG. 7 shows a system 26d having an inductive rechargeable handheld tool battery apparatus 10d according to the present invention, a contact-based handheld tool charging apparatus 28.1d, an inductive handheld tool charging apparatus 28.2d, a rechargeable handheld tool battery apparatus 76d, and an adapter apparatus 78d. Inductive rechargeable handheld tool battery apparatus 10d is embodied correspondingly to inductive rechargeable handheld tool battery apparatus 10a of the first exemplifying embodiment of FIGS. 1 to 3. Contact-based handheld tool charging apparatus 28.1d and inductive handheld tool charging apparatus 28.2d are respectively embodied correspondingly to contact-based handheld tool charging apparatus 28.1b and to inductive handheld tool charging apparatus 28.2b of the second exemplifying embodiment of FIGS. 4 and 5. Inductive rechargeable handheld tool battery apparatus 10d is depicted here disposed on contact-based handheld tool charging apparatus 28.1d for charging.

Rechargeable handheld tool battery apparatus 76d is constituted by a conventional rechargeable handheld tool battery apparatus. Rechargeable handheld tool battery apparatus 76d has only one charging interface, not further visible, constituted by a wire-based contact charging interface. The charging interface of rechargeable handheld tool battery apparatus 76d is embodied correspondingly to the wire-based contact charging interface of inductive rechargeable handheld tool battery apparatus 10d.

Adapter apparatus 78d of system 26d is provided for universal energy transfer. Adapter apparatus 78d has an integrated charging interface 80d. Charging interface 80d is constituted by an induction coil. Charging interface 80d is provided in order to inductively accept a charging energy of inductive handheld tool charging apparatus 28.2d. Charging interface 80d is embodied annularly. Charging interface 80d is made up of multiple electrical conductors that extend in a circumferential direction.

Adapter apparatus 78d furthermore has an attachment region 82d. Attachment region 82d serves to accept the wire-based contact charging interface of rechargeable handheld tool battery apparatus 76d. Rechargeable handheld tool battery apparatus 76d can be slid, with an acceptance region that is not further visible, onto attachment region 82d of adapter apparatus 78d. In a slid-on state, an electronic system of adapter apparatus 78d is electrically conductively connected to rechargeable handheld tool battery apparatus 76d. Adapter apparatus 78d has for this purpose, in attachment region 82d, electrically conductive contact elements (not further visible) that make contact with contact elements, disposed in the acceptance region, of rechargeable handheld tool battery apparatus 76d. An energy can be transferred via the contact elements from adapter apparatus 78d to rechargeable handheld tool battery apparatus 76d.

In order to charge a cell unit of rechargeable handheld tool battery apparatus 76d by way of handheld tool charging apparatus 28.2d, rechargeable handheld tool battery apparatus 76d is slid onto adapter apparatus 78d and adapter apparatus 78d is placed with a base side onto an inductive charging surface 44d of inductive handheld tool charging apparatus 28.2d.

Inductive handheld tool charging apparatus 28.2d is provided for wireless energy transfer to adapter apparatus 78d, which transfers an energy via attachment region 82d to rechargeable handheld tool battery apparatus 76d. Inductive handheld tool charging apparatus 28.2d is provided in order to convert electrical energy into a magnetic field that can then be converted, by charging interface 80d of adapter apparatus 78d, back into electrical energy. Inductive handheld tool charging apparatus 28.2d has for this purpose a charging coil 60d.

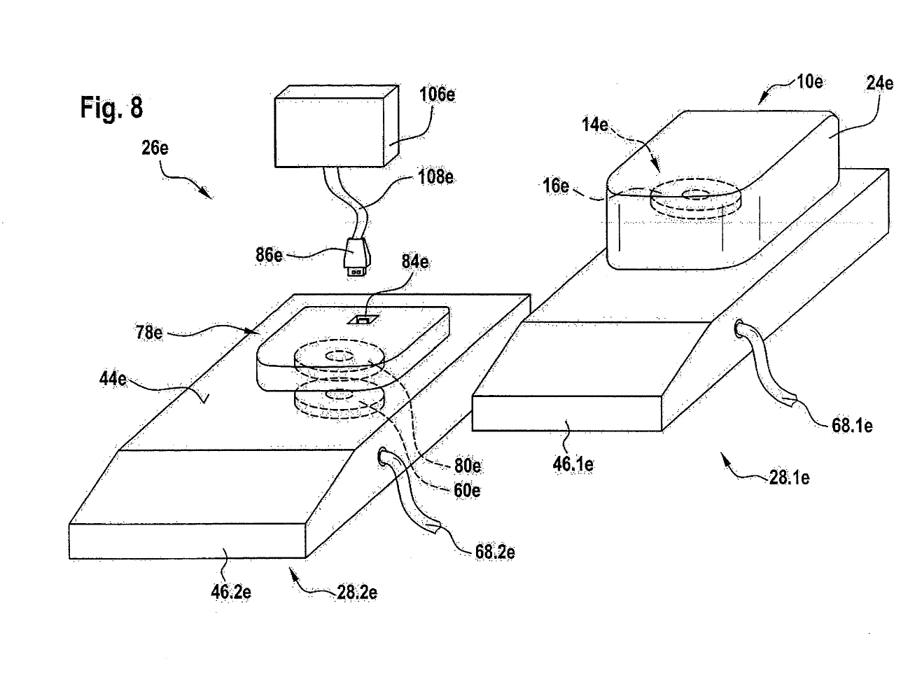

FIG. 8 shows a system 26e having an inductive rechargeable handheld tool battery apparatus 10e according to the present invention, a contact-based handheld tool charging apparatus 28.1e, an inductive rechargeable handheld tool battery apparatus 28.2e, and an adapter apparatus 78e. Inductive rechargeable handheld tool battery apparatus 10e is embodied correspondingly to inductive rechargeable handheld tool battery apparatus 10a of the first exemplifying embodiment of FIGS. 1 to 3. Contact-based handheld tool charging apparatus 28.1e and inductive handheld tool charging apparatus 28.2e are respectively embodied correspondingly to contact-based handheld tool charging apparatus 28.1b and to inductive handheld tool charging apparatus 28.2b of the second exemplifying embodiment of FIGS. 4 and 5. Inductive rechargeable handheld tool battery apparatus 10e is depicted here disposed on contact-based handheld tool charging apparatus 28.1e for charging.

FIG. 8 furthermore shows a device 106e having a charging cable 108e. Device 106e is constituted by a smartphone. Other devices 106e that seem useful to one skilled in the art are in principle also conceivable, however, in particular devices 106e that can be operated and/or charged with a USB charging cable.

Adapter apparatus 78e of system 26e is provided for universal energy transfer. Adapter apparatus 78e has an integrated charging interface 80e. Charging interface 80e is constituted by an induction coil. Charging interface 80e is provided in order to inductively accept a charging energy of inductive handheld tool charging apparatus 28.2e. Charging interface 80e is embodied annularly. Charging interface 80e is made up of multiple electrical conductors that extend in a circumferential direction.

Adapter 78e furthermore has a USB socket 84e. USB socket 84e is provided for acceptance of a USB plug connector 86e. USB socket 84e is provided in order to accept USB plug connector 86e of charging cable 108e of device 106e. In principle, however, any other USB plug connectors can also be accepted in USB socket 84e. USB socket 84e is connected to charging interface 80e for energy transfer. Energy can in turn be transferred via USB socket 84e via charging cable 108e to device 106e.

In order to charge a rechargeable battery, not further visible, of device 106e by way of handheld tool charging apparatus 28.2e, the device is connected by way of charging cable 108e to adapter apparatus 78e, and adapter apparatus 78e is placed with a base side on an inductive charging surface 44e of inductive handheld tool charging apparatus 28.2e.

Inductive handheld tool charging apparatus 28.2e is provided for wireless energy transfer to adapter apparatus 78e, which transfers an energy via charging cable 108e to device 106e. Inductive handheld tool charging apparatus 28.2 is provided in order to convert electrical energy into a magnetic field that can in turn be converted, by charging interface 80e of adapter apparatus 78e, back into electrical energy. Inductive handheld tool charging apparatus 28.2e has for this purpose a charging coil 60e.

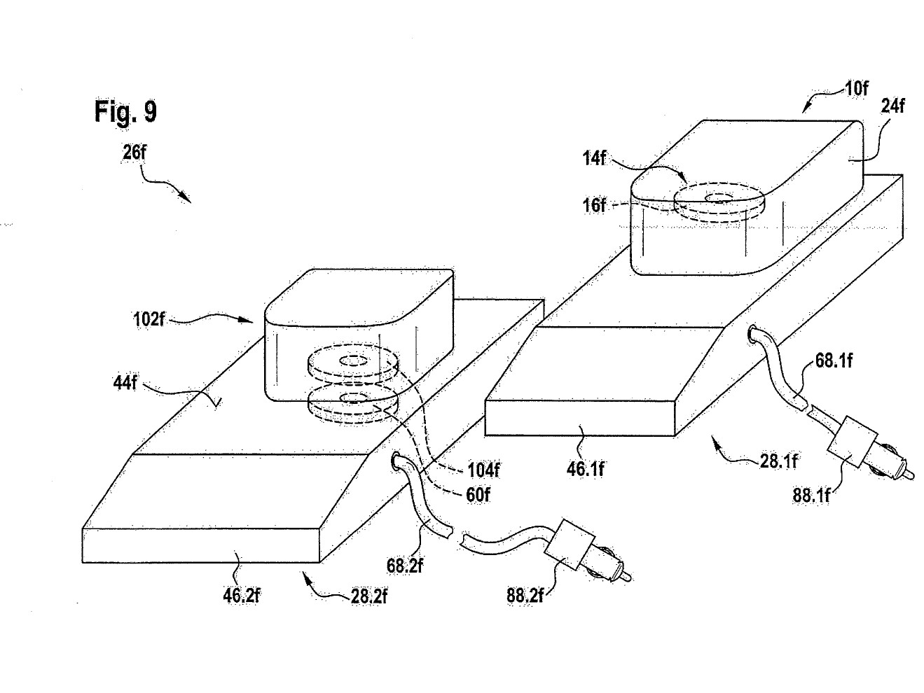

FIG. 9 shows a system 26f having an inductive rechargeable handheld tool battery apparatus 10f according to the present invention, an alternative contact-based handheld tool charging apparatus 28.1f, and an alternative inductive handheld tool charging apparatus 28.2f. The system furthermore has a further inductive rechargeable handheld tool battery apparatus 102f.

Inductive rechargeable handheld tool battery apparatus 10f is embodied correspondingly to inductive rechargeable handheld tool battery apparatus 10a of the first exemplifying embodiment of FIGS. 1 to 3. Contact-based handheld tool charging apparatus 28.1f and inductive handheld tool charging apparatus 28.2f are respectively embodied approximately correspondingly to contact-based handheld tool charging apparatus 28.1b and to inductive handheld tool charging apparatus 28.2b of the second exemplifying embodiment of FIGS. 4 and 5.

Inductive handheld tool charging apparatus 28.2f is provided for wireless energy transfer to inductive rechargeable handheld tool battery apparatus 10f. Inductive handheld tool charging apparatus 28.2 has for this purpose a charging coil 60f. Inductive handheld tool charging apparatus 28.2f furthermore has a core unit that is not further visible, an inductive charging electronic system that is not further visible, and a shielding unit that is not further visible. Inductive handheld tool charging apparatus 28.2f has a cable 68.2 for energy supply. The inductive charging electronic system is connected, in a manner not further visible, to cable 68.2f for energy delivery. Cable 68.2f has a plug connector 88.2f that is constituted by a vehicle plug connector. Plug connector 88.2f is provided in order to be inserted into a vehicle voltage socket of a motor vehicle.

Contact-based handheld tool charging apparatus 28.1f likewise has a cable 68.1f for energy supply. Contact-based handheld tool charging apparatus 28.1f furthermore has a contact charging electronic system, not further visible, that is connected in a manner not further visible to cable 68.1f for energy delivery. Cable 68.1f has a plug connector 88.1f that is constituted by a motor vehicle plug connector. Plug connector 88.1f is provided in order to be inserted into a vehicle voltage socket of a motor vehicle.

Further inductive rechargeable handheld tool battery apparatus 102f has only one charging interface 104f, constituted by an inductive charging interface. Charging interface 104f serves both to transfer energy from inductive handheld tool charging apparatus 28.2f to inductive rechargeable handheld tool battery apparatus 102f and to transfer energy from inductive rechargeable handheld tool battery apparatus 102f to a handheld tool or to a handheld power tool.

FIG. 10 shows a system 26g having an inductive rechargeable handheld tool battery apparatus log according to the present invention, a contact-based handheld tool charging apparatus that is not further visible, an inductive handheld tool charging apparatus 28.2g, and an attachment unit 90g. System 26g furthermore has a handheld power tool 20g. Inductive rechargeable handheld tool battery apparatus log and handheld power tool 20g are embodied correspondingly to inductive rechargeable handheld tool battery apparatus 10a and to handheld power tool 20a of the first exemplifying embodiment of FIGS. 1 to 3. The contact-based handheld tool charging apparatus that is not further visible, and inductive handheld tool charging apparatus 28.2g, are respectively embodied correspondingly to contact-based handheld tool charging apparatus 28.1b and to inductive handheld tool charging apparatus 28.2b of the second exemplifying embodiment of FIGS. 4 and 5.

Attachment unit 90 is constituted by an aluminum frame. Other materials and/or material combinations that seem useful to one skilled in the art would, however, also be conceivable in principle. Handheld tool charging apparatus 28.2g is accepted in lossproof fashion in attachment unit 90g. Handheld tool charging apparatus 28.2g is disposed on an inner side of a base side of attachment unit 90g and held there in positively fitting fashion in a manner not further visible. Handheld tool charging apparatus 28.2g is latchingly connected to attachment unit 90g.

Attachment unit 90g is furthermore provided in order to accept in lossproof fashion an object that is to be charged, directly for charging. Attachment unit 90g is provided in order to accept in lossproof fashion, inductive rechargeable handheld tool battery apparatus log for charging. Attachment unit 90g is furthermore provided in order to accept in lossproof fashion inductive rechargeable handheld tool battery apparatus 10g, having handheld power tool 20g attached thereto, for charging of inductive rechargeable handheld tool battery apparatus 10g. Inductive rechargeable handheld tool battery apparatus log can be slid, in a state connected to handheld power tool 20g, into attachment unit 90g. Inductive rechargeable handheld tool battery apparatus log and handheld power tool 20g are held in positively fitting fashion, in a manner not further visible, in attachment unit 90g. In addition, inductive rechargeable handheld tool battery apparatus log is oriented by attachment unit 90g relative to handheld tool charging apparatus 28.2g. Inductive rechargeable handheld tool battery apparatus log is held by way of attachment unit 90g during a charging operation.

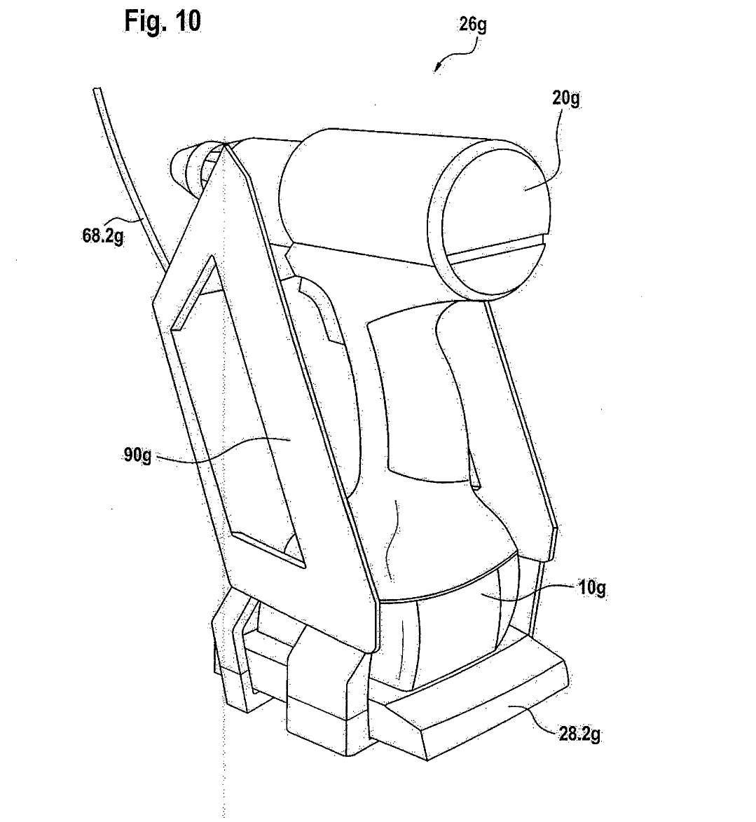

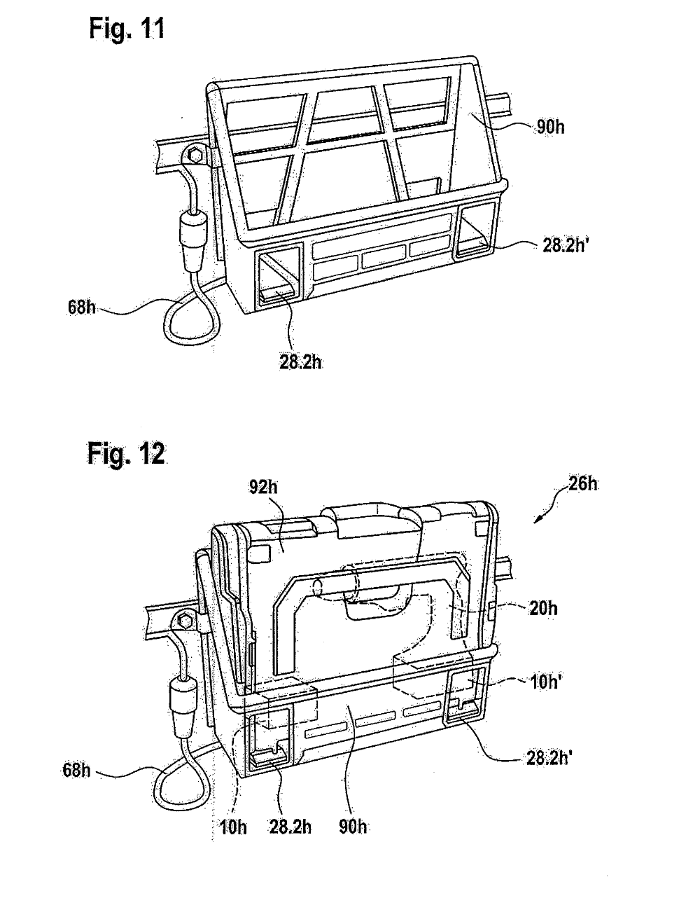

FIG. 11 shows two inductive handheld tool charging apparatuses 28.2h, 28.2h′ and an attachment unit 90h. FIG. 12 shows a system 26h having two inductive rechargeable handheld tool battery apparatuses 10h, 10h′ according to the present invention, a case 92h in which inductive rechargeable handheld tool battery apparatuses 10h, 10h′ are accepted, a contact-based handheld tool charging apparatus that is not further visible, the two inductive handheld tool charging apparatuses 28.2h, 28.2h′, and attachment unit 90h. System 26h furthermore has a handheld power tool 20h. Inductive rechargeable handheld tool battery apparatus 10h and handheld power tool 20h are embodied correspondingly to inductive rechargeable handheld tool battery apparatus 20a and to handheld power tool 20a of the first exemplifying embodiment of FIGS. 1 to 3. The contact-based handheld tool charging apparatus that is not further visible, and inductive handheld tool charging apparatus 28.2h, are respectively embodied correspondingly to contact-based handheld tool charging apparatus 28.1f and to inductive handheld tool charging apparatus 28.2f of the sixth exemplifying embodiment of FIG. 9. Inductive handheld tool charging apparatus 28.2h has a cable 68.2h for energy supply. Cable 68.2h has a plug connector, not further visible, that is constituted by a motor vehicle plug connector. The plug connector is provided in order to be inserted into a vehicle voltage socket of a motor vehicle.

Attachment unit 90h is constituted by a box, made of plastic, opened toward the top. Other shapes, materials, and/or material combinations that seem useful to one skilled in the art would, however, also be conceivable in principle. The two handheld tool charging apparatuses 28.2h, 28.2h′ are accepted in lossproof fashion in attachment unit 90h. Handheld tool charging apparatuses 28.2h, 28.2h′ are disposed on an inner side of a base side of attachment unit 90h, respectively at two oppositely located ends, and are held there in positively fitting fashion in a manner not further visible. Attachment unit 90h has several lateral and frontal openings so that handheld tool charging apparatuses 28.2h, 28.2h′ are accessible from the front. Handheld tool charging apparatuses 28.2h, 28.2h′ are latchingly connected to attachment unit 90h.

Attachment unit 90h is furthermore provided in order to accept in lossproof fashion an object that is to be charged, directly for charging. Attachment unit 90h is provided in order to accept, in lossproof fashion, inductive rechargeable handheld tool battery apparatuses 10h, 10h′ for charging. Attachment unit 90h is furthermore provided in order to accept in lossproof fashion inductive rechargeable handheld tool battery apparatus 10h′, having handheld power tool 20h attached thereto, for charging of inductive rechargeable handheld tool battery apparatus 10h′. Attachment unit 90h is provided in order to accept, in lossproof fashion, case 92h in which the two inductive rechargeable handheld tool battery apparatuses 10h, 10h′ are accepted, for charging of inductive rechargeable handheld tool battery apparatuses 10h, 10h′. Inductive rechargeable handheld tool battery apparatus 10h as well as inductive rechargeable handheld tool battery apparatus 10h′, together with handheld power tool 20h, can be inserted into attachment unit 90h while disposed in case 92h. Case 92h is held in attachment unit 90h in positively fitting fashion, in a manner not further visible. Inductive rechargeable handheld tool battery apparatuses 10h, 10h′ are furthermore oriented by case 92h and by attachment unit 90h relative to handheld tool charging apparatus 28.2h, 28.2h′. Inductive rechargeable handheld tool battery apparatuses 10h, 10h′ are held in securely positioned fashion in case 92h. Inductive rechargeable handheld tool battery apparatuses 10h, 10h′ can thus be charged directly in case 92h.

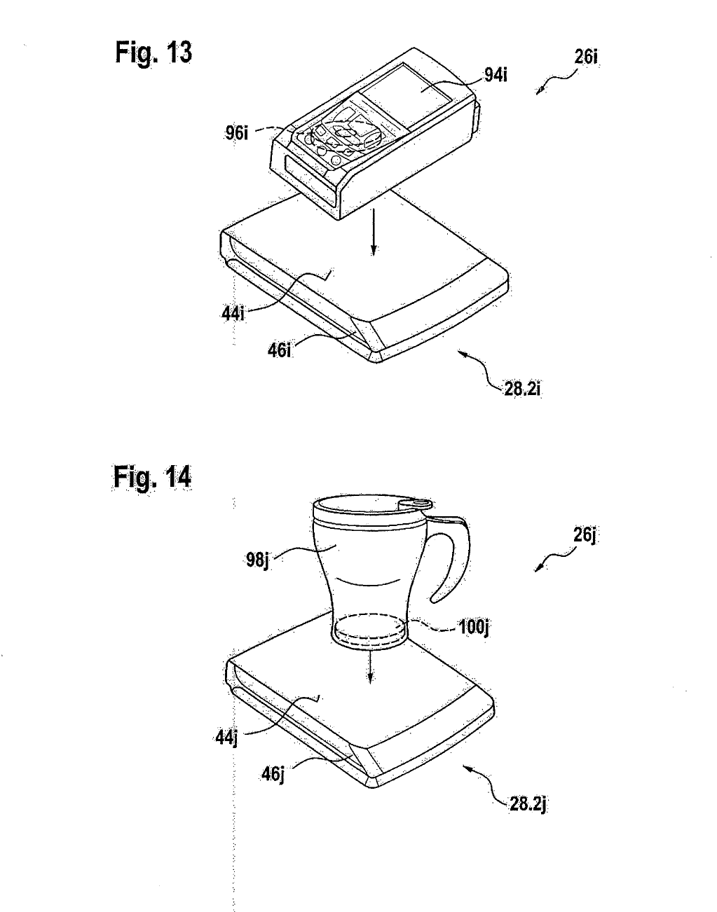

FIG. 13 shows a system 26i having an inductive rechargeable handheld tool battery apparatus according to the present invention that is not further visible, a contact-based handheld tool charging apparatus that is not further visible, an inductive handheld tool charging apparatus 28.2i, and a handheld tool 94i. The inductive rechargeable handheld tool battery apparatus is embodied correspondingly to inductive rechargeable handheld tool battery apparatus 10a of the first exemplifying embodiment of FIGS. 1 to 3. The contact-based handheld tool charging apparatus that is not further visible, and inductive handheld tool charging apparatus 28.2i, are respectively embodied correspondingly to contact-based handheld tool charging apparatus 28.1b and to inductive handheld tool charging apparatus 28.2b of the second exemplifying embodiment of FIGS. 4 and 5.

Handheld tool 94i is constituted by a measuring device. Other handheld tools that seem useful to one skilled in the art would, however, also be conceivable in principle. Handheld tool 94i has an integrated charging interface 96i. Charging interface 96i of handheld tool 94i is constituted by an induction coil. Handheld tool 94i can be charged via charging interface 96i by way of handheld tool charging apparatus 28.2i. Handheld tool 94i can be charged inductively by way of handheld tool charging apparatus 28.2i via charging interface 96i.

FIG. 14 shows a system 26j having an inductive rechargeable handheld tool battery apparatus according to the present invention that is not further visible, a contact-based handheld tool charging apparatus that is not further visible, an inductive handheld tool charging apparatus 28.2j, and a thermally insulated container 98j. The inductive rechargeable handheld tool battery apparatus is embodied correspondingly to inductive rechargeable handheld tool battery apparatus 10a of the first exemplifying embodiment of FIGS. 1 to 3. The contact-based handheld tool charging apparatus that is not further visible, and inductive handheld tool charging apparatus 28.2j, are respectively embodied correspondingly to contact-based handheld tool charging apparatus 28.1b and to inductive handheld tool charging apparatus 28.2b of the second exemplifying embodiment of FIGS. 4 and 5.

Thermally insulated container 98j is constituted by an insulated cup. Other configurations of thermally insulated container 98j that seem useful to one skilled in the art would, however, also be conceivable in principle. Thermally insulated container 98j has a magnetic heating element 100j. Magnetic heating element 100j is constituted by a ferromagnetic heating element 100j. Magnetic heating element 100j is constituted by an iron plate disposed in the bottom of thermally insulated container 100j. Other shapes and/or materials for magnetic heating element 100j would, however, also be conceivable in principle. Magnetic heating element 100j is configured to be inductively heatable via handheld tool charging apparatus 28.2j. Magnetic heating element 100j becomes heated by the alternating magnetic field proceeding from handheld tool charging apparatus 28.2j and can thus heat what is contained in thermally insulated container 98j.

1-28. (canceled)

29. An inductive rechargeable handheld tool battery apparatus, comprising:
a cell unit; and
a secondary charging unit configured for direct energy acceptance upon charging of the cell unit, wherein the secondary charging unit has at least one first integrated charging interface and at least one second integrated charging interface, the at least one first integrated charging interface including an induction coil.

30. The inductive rechargeable handheld tool battery apparatus as recited in claim 29, wherein the at least first integrated charging interface is nondetachably connected to the cell unit.

31. The inductive rechargeable handheld tool battery apparatus as recited in claim 30, wherein the second integrated charging interface includes a wire-based contact charging interface.

32. The inductive rechargeable handheld tool battery apparatus as recited in claim 29, wherein at least one of the first integrated charging interface and the second integrated charging interface is configured to transfer energy of the cell unit to a handheld power tool, in addition to direct energy acceptance upon charging of the cell unit.

33. The inductive rechargeable handheld tool battery apparatus as recited in claim 32, wherein the second integrated charging interface is configured to transfer energy of the cell unit to the handheld power tool, in addition to direct energy acceptance upon charging of the cell unit.

34. The inductive rechargeable handheld tool battery apparatus as recited in claim 32, wherein the secondary charging unit has a calculation unit configured to at least one of control and regulate a charging operation of the cell unit via the first integrated charging interface and via the second integrated charging interface.

35. The inductive rechargeable handheld tool battery apparatus as recited in claim 32, further comprising:
a housing unit.

36. The inductive rechargeable handheld tool battery apparatus as recited in claim 35, wherein the first integrated charging interface and the second integrated charging interface are disposed in integrated fashion in the housing unit.

37. The inductive rechargeable handheld tool battery apparatus as recited in claim 36, wherein the first integrated charging interface is disposed on a side of the housing unit which is located at least approximately opposite the second integrated charging interface.

38. A system, comprising:
a handheld tool charging apparatus; and
an inductive rechargeable handheld tool battery apparatus including:
a cell unit; and
a secondary charging unit configured for direct energy acceptance upon charging of the cell unit, wherein the secondary charging unit has at least one first integrated charging interface and at least one second integrated charging interface, the at least one first integrated charging interface including an induction coil, wherein at least one of the first integrated charging interface and the second integrated charging interface is configured to transfer energy of the cell unit to a handheld power tool, in addition to direct energy acceptance upon charging of the cell unit.

39. The system as recited in claim 38, wherein the handheld tool charging apparatus is a contact-based handheld tool charging apparatus.

40. The system at least as recited in claim 38, wherein the handheld tool charging apparatus is an inductive handheld tool charging apparatus.

41. The system as recited in claim 38, further comprising:
at least one further handheld tool charging apparatus which is an inductive handheld tool charging apparatus.

42. The system as recited in claim 38, wherein the handheld tool charging apparatus is provided in order to charge the inductive rechargeable handheld tool battery apparatus, wherein the inductive rechargeable handheld tool battery apparatus has at least two different rated voltages.

43. The system as recited in claim 38, wherein the rechargeable handheld tool battery apparatus has only one charging interface configured as a wire-based contact charging interface.

44. The system as recited in claim 38, further comprising:
an adapter apparatus for universal energy transfer and having at least one integrated charging interface configured as an induction coil.

45. The system as recited in claim 44, wherein the adapter apparatus has at least one attachment region for acceptance of a wire-based contact charging interface of the rechargeable handheld tool battery apparatus.

46. The system as recited in claim 44, wherein the adapter apparatus has at least one USB socket for acceptance of a USB plug connector.

47. The system as recited in claim 44, wherein the handheld tool charging apparatus has at least one cable for supplying energy, the at least one cable having at least one plug connector configured as a motor vehicle plug connector.

48. The system as recited in claim 38, further comprising:
a handheld power tool.

49. The system as recited in claim 38, further comprising:
at least one attachment unit in which (i) the handheld tool charging apparatus is securely accommodated and (ii) an object to be charged is securely accommodated for charging.

50. The system as recited in claim 49, wherein the at least one attachment unit is configured to securely accommodate the inductive rechargeable handheld tool battery apparatus for charging.

51. The system as recited in claim 49, wherein the at least one attachment unit is configured to securely accommodate the inductive rechargeable handheld tool battery apparatus attached to the handheld power tool, for charging of the inductive rechargeable handheld tool battery apparatus.

52. The system at least as recited in claim 49, wherein the at least one attachment unit is configured to securely accommodate a case in which the inductive rechargeable handheld tool battery apparatus is accepted, for charging of the inductive rechargeable handheld tool battery apparatus.

53. The system as recited in claim 38, further comprising:
at least one handheld tool having at least one integrated charging interface including an induction coil, wherein the handheld tool is chargeable via the induction coil by the handheld tool charging apparatus.

54. The system as recited in claim 38, further comprising:
at least one thermally insulated container having at least one magnetic heating element configured to be inductively heated via the handheld tool charging apparatus.

55. The system as recited in claim 38, further comprising:
a further inductive rechargeable handheld tool battery apparatus having only one charging interface configured as a wire-based contact charging interface.
